(19) United States
(12) Patent Application Publication
(10) Pub. No.: US 2025/0087741 A1
(43) Pub. Date: Mar. 13, 2025

(54) COMPOSITE SOLID ELECTROLYTE AND ALL SOLID STATE BATERRY COMPRISING THE SAME

(71) Applicant: SAMSUNG ELECTRO-MECHANICS CO., LTD., Suwon-si, Gyeonggi-do (KR)

(72) Inventors: Jieun Wang, Suwon-si, Gyeonggi-do (KR); Myung Jin Jung, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/292,874

(22) PCT Filed: Jan. 4, 2024
(86) PCT No.: PCT/KR2024/000203

§ 371 Date: Jan. 26, 2024

(30) Foreign Application Priority Data
Apr. 14, 2023 (KR) 10-2023-0049292

(51) Int. Cl. H01M 10/0562; H01M 10/0525

(52) U.S. Cl. CPC H01M 10/0562; H01M 10/0525; H01M 2300/008

(57) ABSTRACT

A composite solid electrolyte according to the present disclosure includes a Garnet-type solid electrolyte and a LISICON-type solid electrolyte containing Cl element. The LISICON-type solid electrolyte is represented by LiₐM_{b}P_{c}Cl_{d}Oₑ, in which M includes Zn, Al, Ga, Si, Ge, Ti, Mg, or a combination thereof, and a, b, c, d, and e are molar ratios of each component and satsify 5≤a≤12, 0<b≤3, 0<c≤3, 0<d≤0.1, and 10≤e≤12.

### CROSS-REFERENCE TO RELATED APPLICATION

This application claims priority to and the benefit of Korean Patent Application No. 10-2023-0049292 filed in the Korean Intellectual Property Office on Apr. 14, 2023, the entire contents of which are incorporated herein by reference.

### TECHNICAL FIELD

The present disclosure relates to a composite solid electrolyte and an all-solid-state battery including the same.

### BACKGROUND ART

Recently, as portable electronic devices are required to be down-sized and used for a long term, high-capacity batteries are required, and safety of the batteries is also required due to the spread of wearable electronic devices. Accordingly, development of an all-solid-state battery using a solid electrolyte instead of a liquid electrolyte is actively progressing.

Since the all-solid-state battery does not use a flammable organic solvent, additional circuitry for safety may be simplified. Therefore, the all-solid-state battery is expected as a technology capable of manufacturing a safe battery with high capacity per unit volume.

In addition, an oxide all-solid-state battery using an oxide electrolyte with lower ionic conductivity (10⁻⁴ S/cm to 10⁻⁶ S/cm) than a sulfide electrolyte (10⁻² S/cm) requires a high-temperature sintering process but exhibits excellent stability, compared with a sulfide all-solid-state battery using the sulfide electrolyte which reacts oxygen and moisture in the air.

When the oxide electrolyte conventionally uses a material including V (Vanadium), there is a problem of causing an oxidation-reduction reaction within a voltage range of 0.5 to 1.5 V, compared with a lithium metal (vs. Li/Li+). This oxidation-reduction reaction of the vanadium is a side reaction, which makes it difficult for the all-solid-state battery to normally operate and thus makes the all-solid-state battery operate only within a voltage range of 1.5 V or higher.

In addition, a Garnet-type electrolyte, which is a type of conventional oxide electrolyte, also has disadvantages of high relative density and high firing temperature.

### DISCLOSURE

One aspect of the embodiment provides a composite solid electrolyte that can lower a firing temperature, does not cause side reactions in an operating voltage range of 0 to 6V, has a high relative density, and has high lithium ionic conductivity.

Another aspect of the embodiment provides an all-solid-state battery including the same.

However, problems to be solved by the embodiments are not limited to the above-described problems and may be variously expanded within the range of technical ideas included in the embodiments.

A composite solid electrolyte according to an embodiment includes a Garnet-type solid electrolyte; and a LISICON-type solid electrolyte containing Cl element. The LISICON-type solid electrolyte is represented by Chemical Formula 1.

LiₐM_{b}P_{c}Cl_{d}Oₑ [Chemical Formula 1]
M includes Zn, Al, Ga, Si, Ge, Ti, Mg, or a combination thereof, and
a, b, c, d, and e are molar ratios of each component, and satisfy 5≤a≤12, 0<b≤3, 0<c≤3, 0<d≤0.1, and 10≤e≤12.

The M may include Si (silicon) or Ge (germanium).

The M may not include V (vanadium).

The composite solid electrolyte may further include an oxide containing Li and B elements.

The oxide containing the Li and B elements may include Li₃BO₃, Li₄B₂O₅, LiBO₂, or a combination thereof.

The Garnet-type solid electrolyte may be included in an amount of 10 to 50 vol % based on the total volume of the composite solid electrolyte.

The LISICON-type solid electrolyte may be included in an amount of 40 to 80 vol % based on the total volume of the composite solid electrolyte.

The oxide containing Li and B elements may be included in an amount of 5 to 20 vol % based on the total volume of the composite solid electrolyte.

A volume ratio of the Garnet-type solid electrolyte and the LISICON-type solid electrolyte may be 10:80 to 45:45.

A volume ratio of a sum of the Garnet-type solid electrolyte and the LISICON-type solid electrolyte and the oxide containing Li and B elements may be 80:20 to 90:10.

The composite solid electrolyte may have a relative density (%) of greater than or equal to 80%.

The composite solid electrolyte may have room-temperature (25° C.) lithium ionic conductivity of greater than or equal to 1×10⁻⁷ (S/cm).

LiₐM_{b}P_{c}Cl_{d}Oₑ may include Li_{10.42}Si_{1.5}P_{1.5}Cl_{0.08}O_{11.92}.

An all-solid-state battery according to another embodiment includes a solid electrolyte layer; and a positive electrode layer and a negative electrode layer with the solid electrolyte layer disposed therebetween. The solid electrolyte layer includes a composite solid electrolyte, the composite solid electrolyte includes a Garnet (LLZO)-type solid electrolyte and a Cl element and a LISICON solid electrolyte, and the LISICON-type solid electrolyte is represented by Chemical Formula 1.

LiₐM_{b}P_{c}Cl_{d}Oₑ [Chemical Formula 1]
M includes Zn, Al, Ga, Si, Ge, Ti, Mg, or a combination thereof, and
a, b, c, d, and e are molar ratios of each component, and satisfy 5≤a≤12, 0<b≤3, 0<c≤3, 0<d≤0.1, and 10≤e≤12.

The composite solid electrolyte may further include an oxide containing Li and B elements.

An all-solid-state battery according to another embodiment includes a stack including a plurality of solid electrolyte layers and a plurality of positive electrode layers and negative electrode layers alternately with the plurality of solid electrolyte layers disposed therebetween, and first and second external electrodes disposed on one surface and the other surface opposite to the one surface of the stack and connected to the positive electrode layer and negative electrode layer, respectively. The solid electrolyte layers include a composite solid electrolyte, and the composite solid electrolyte includes a Garnet (LLZO)-type solid electrolyte and a LISICON-type solid electrolyte containing a Cl element, and the LISICON-type solid electrolyte is represented by Chemical Formula 1.

LiₐM_{b}P_{c}Cl_{d}Oₑ [Chemical Formula 1]
M includes Zn, Al, Ga, Si, Ge, Ti, Mg, or a combination thereof, and
a, b, c, d, and e are molar ratios of each component, and satisfy 5≤a≤12, 0<b≤3, 0<c≤3, 0<d≤0.1, and 10≤e≤12.

The composite solid electrolyte may further include an oxide containing Li and B elements.

According to the composite solid electrolyte according to the embodiment, the firing temperature may be lowered, side reactions do not occur in the operating voltage range of 0 to 6 V, the relative density is high, and the lithium ionic conductivity is high.

An all-solid-state battery including the same has the advantage that it can be driven in all of the operating voltage range of 0 to 6 V because no side reaction occurs in the operating voltage range of 0.75 to 1.5 V. In addition, since there is no need to avoid the side reaction range, there is an advantage in that the types of selectable electrode active materials are expanded.

However, the various advantageous advantages and effects of the present invention are not limited to the above descriptions, and will be more easily understood in the process of describing specific embodiments of the present invention.

### DESCRIPTION OF THE DRAWINGS

FIG. 1 is a perspective view schematically illustrating an all-solid-state battery according to an embodiment.

FIG. 2 is a cross-sectional view of an all-solid-state battery according to the embodiment shown in FIG. 1.

FIG. 3 is an exploded perspective view schematically illustrating a unit cell stack structure of an all-solid-state battery according to the embodiment shown in FIG. 1.

FIG. 4 is a graph showing the side reaction analysis results of Example 1, Example 2, Comparative Example 9, and Comparative Example 10.

### MODE FOR INVENTION

Hereinafter, various embodiments of the present invention will be described in detail with reference to the accompanying drawings so that those skilled in the art may easily carry out the present invention. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and sustitutions without departing from the scope and spirit of the present invention. In addition, some constituent elements in the accompanying drawings are exaggerated, omitted, or schematically illustrated, and the size of each constituent element does not entirely reflect the actual size.

In addition, unless explicitly described to the contrary, the word “comprise”, and variations such as “comprises” or “comprising”, will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “side direction” refers to a direction extending parallel to the large surface (main surface) from the edge of the sheet-shaped constituent elements or a “planar direction”, which corresponds to an L-axis direction in the drawing. Further, the W-axis direction in the drawing may be a “width direction”.

Hereinafter, various embodiments and modifications will be described in detail with reference to the drawings.

A composite solid electrolyte according to an embodiment includes a Garnet-type solid electrolyte and a LISICON-type solid electrolyte containing a Cl element.

The Garnet-type solid electrolyte is a type of oxide-based solid electrolyte, and has advantages in that it has high lithium ionic conductivity and high stability even at high temperatures with Li metal.

The Garnet-type solid electrolyte may mean lithium-lanthanum-zirconium oxide (LLZO) represented by LiₓLa_{y}Zr_{z}A_{w}O₁₂.

The A may include Ga, Gd, Al, Mg, Zn, Sc, Nb, Ta, Bi, or a combination thereof.

The x, y, z, and w are molar ratios of each component, and may be 6<x≤7, 2<y≤3, 1.5<z≤2, and 0≤w≤0.5. For example, the Garnet-type solid electrolyte may include Li₇La₃Zr₂O₁₂, Li_{6.25}Al_{0.25}La₃Zr₂O₁₂, Li_{6.4}Ga_{0.2}La₃Zr₂O₁₂, Li_{6.75}La₃Zr_{1.75}Nb_{0.25}O₁₂, Li_{6.75}La₃Zr_{1.75}Ta_{0.25}O₁₂, Li_{6.75}La₃Zr_{1.75}Al_{0.25}O₁₂, or Li_{6.4}Ga_{0.2}La_{2.95}Ga_{0.05}Zr₂O₁₂.

The LISICON-type (Li super ionic conductor) solid electrolyte is an oxide containing a Cl element.

For example, the LISICON-type solid electrolyte may be an oxide containing a Li element, a Si element, a Ge element, a P element, and a Cl element.

For example, the LISICON-type solid electrolyte is represented by Chemical Formula 1.

LiₐM_{b}P_{c}Cl_{d}Oₑ [Chemical Formula 1]
M includes Zn, Al, Ga, Si, Ge, Ti, Mg, or a combination thereof.

For example, the M may include Si (silicon) or Ge (germanium), and for example, the M may not include V (vanadium).

The a, b, c, d, and e are molar ratios of each component, 5≤a≤12, 0<b≤3, 0<c≤3, 0<d≤0.1, and 10≤e≤12.

In Chemical Formula 1, 10≤a≤12, or 10≤a≤11 may be satisfied.

In Chemical Formula 1, 1≤b≤3 or 1≤b≤1.5 may be satisfied.

In Chemical Formula 1, 1≤c≤3 or 1≤c≤1.5 may be satisfied.

In Chemical Formula 1, 0.05≤d≤0.1 may be satisfied.

In Chemical Formula 1, 11≤e≤12 or 11.5≤e≤12 may be satisfied.

For example, in Chemical Formula 1, 0<d+e≤12 may be satisfied.

For example, the LISICON-type solid electrolyte may include Li_{10.42}Ge_{1.5}P_{1.5}Cl_{0.08}O_{11.92} or Li_{10.42}Si_{1.5}P_{1.5}Cl_{0.08}O_{11.92}, and as a more specific example, Li_{10.42}Si_{1.5}P_{1.5}Cl_{0.08}O_{11.92}. For example, the LISICON-type solid electrolyte may not include a LISICON-type solid electrolyte containing V (vanadium) such as Li_{3.2}(V_{0.8}Si_{0.2})O₄.

Since the LISICON-type solid electrolyte is doped with Cl element, lithium ionic conductivity is particularly high, and side reactions that hinder battery driving can be suppressed.

In addition, since the LISICON-type solid electrolyte does not contain V element, oxidation/reduction reaction of V element does not occur even when the battery is driven, and side reactions can be suppressed.

The composite solid electrolyte according to an embodiment may further include an oxide containing Li and B elements. The oxide containing Li and B elements may be a material added to adjust the process temperature to a low temperature during the firing process. The oxide containing Li and B elements may include Li₃BO₃, Li₄B₂O₅, LiBO₂, or a combination thereof, and specifically Li₃BO₃.

The Garnet-type solid electrolyte may be included in an amount of 10 to 50 vol %, or 20 to 45 vol % based on the total composite solid electrolyte. When the Garnet-type solid electrolyte is included in less than 10 vol % based on the total composite solid electrolyte, lithium ionic conductivity may be lowered, and when it is included in greater than 50 vol %, the relative density of the composite solid electrolyte may be lowered.

The LISICON-type solid electrolyte may be included in an amount of 40 to 80 vol %, or 45 to 65 vol % based on the total composite solid electrolyte. When the LISICON-type solid electrolyte is included in less than 40 vol % based on the total composite solid electrolyte, sinterability may be deteriorated, and when it is included in greater than 80 vol %, ionic conductivity of the composite solid electrolyte may be lowered.

The oxide containing Li and B elements may be included in an amount of 5 to 20 vol %, or 10 to 15 vol % based on the total composite solid electrolyte. When the oxide containing Li and B elements is included in less than 5 vol % based on the total composite solid electrolyte, it is difficult to lower the firing temperature, and when it is included in greater than 20 vol %, the lithium ionic conductivity is lowered.

A volume ratio of the Garnet-type solid electrolyte and the LISICON-type solid electrolyte may be 10:80 to 45:45, or 20:70 to 45:45 based on the total composite solid electrolyte.

A volume ratio of the sum of the Garnet-type solid electrolyte and the LISICON-type solid electrolyte and the oxide containing Li and B elements may be 80:20 to 90:10, or 85:15 to 90:10 based on the total composite solid electrolyte.

A volume ratio of the Garnet-type solid electrolyte, the LISICON-type solid electrolyte, and the oxide containing Li and B elements may be, for example, 45:45:10 based on the total composite solid electrolyte.

For example, the composite solid electrolyte may include a Garnet-type solid electrolyte, Li_{10.42}Si_{1.5}P_{1.5}Cl_{0.08}O_{11.92}, and Li₃BO₃ in a volume ratio of 45:45:10.

For example, the composite solid electrolyte may include a Garnet-type solid electrolyte, Li_{10.42}Si_{1.5}P_{1.5}Cl_{0.08}O_{11.92}, and Li₃BO₃ in a volume ratio of 20:65:15.

A relative density (%) of the composite solid electrolyte according to an embodiment may be greater than or equal to 80%.

The relative density (%) is calculated by dividing an apparent density by a true density, and the apparent density can be calculated using a volume of the material and the apparent volume, and the true density can be obtained from the single crystal X-ray structure analysis result.

When the relative density (%) of the composite solid electrolyte satisfies the above range, the solid electrolyte layer included in the all-solid-state battery may have an ionic conductivity of greater than or equal to 1×10⁻⁷ (S/cm).

The lithium ionic conductivity of the composite solid electrolyte according to an embodiment may be greater than or equal to 1×10⁻⁷ (S/cm), and for example, greater than or equal to 5×10⁻⁷ (S/cm).

The lithium ionic conductivity of the composite solid electrolyte can be measured by an alternating current (AC) impedance method. First, the solid electrolyte layer is exposed in an all-solid-state battery by ion milling or polishing, and a portion of the solid electrolyte layer is sampled as a rectangular plate-shaped piece. Susequently, electrodes made of gold (Au) are formed on both ends of the obtained piece to prepare a sample. Then, the sample is measured for alternating current impedance at room-temperature (25° C.) using an impedance measuring device (frequency: measured from 10⁺⁶ Hz or more to 10⁻¹ Hz or less, voltage: value between 50 mV and 500 mV) to calculate the ionic conductivity.

According to the composite solid electrolyte according to an embodiment, the firing temperature can be lowered, side reactions do not occur in the operating voltage range of 0 to 6V, the relative density is high, and the lithium ionic conductivity is high.

An all-solid-state battery according to an embodiment includes a solid electrolyte layer, a positive electrode layer and a negative electrode layer with the solid electrolyte layer disposed therebetween, and the solid electrolyte layer includes the composite solid electrolyte.

An all-solid-state battery according to another embodiment includes a stack including a plurality of solid electrolyte layers and a plurality of positive electrode layers and negative electrode layers alternately with the plurality of solid electrolyte layers disposed therebetween, and first and second external electrodes disposed on one surface and the other surface opposite to the one surface of the stack and connected to the positive electrode layer and negative electrode layer, respectively. The solid electrolyte layers include the composite solid electrolyte.

The composite solid electrolyte includes a Garnet (LLZO)-type solid electrolyte and a LISICON-type solid electrolyte containing a Cl element, and the LISICON-type solid electrolyte is represented by Chemical Formula 1.

LiₐM_{b}P_{c}Cl_{d}Oₑ [Chemical Formula 1]
M includes Zn, Al, Ga, Si, Ge, Ti, Mg, or a combination thereof, and
a, b, c, d, and e are molar ratios of each component, 5≤a≤12, 0<b≤3, 0<c≤3, 0<d≤0.1, and 10≤e≤12.

The composite solid electrolyte may further include an oxide containing Li and B elements.

Since the composite solid electrolyte is the same as that described above, a detailed description thereof will be omitted.

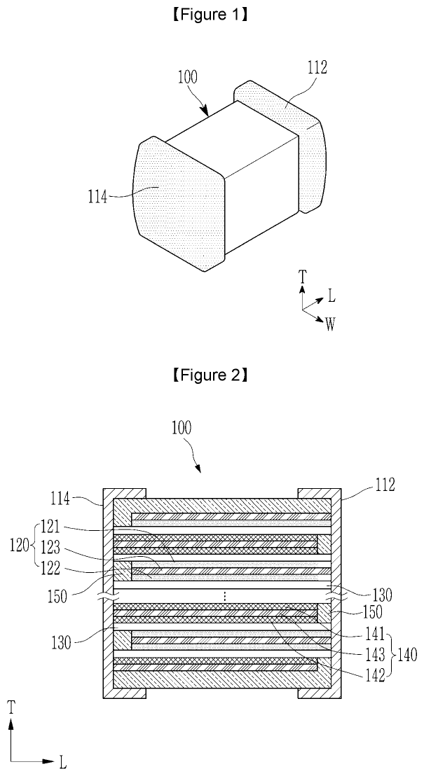

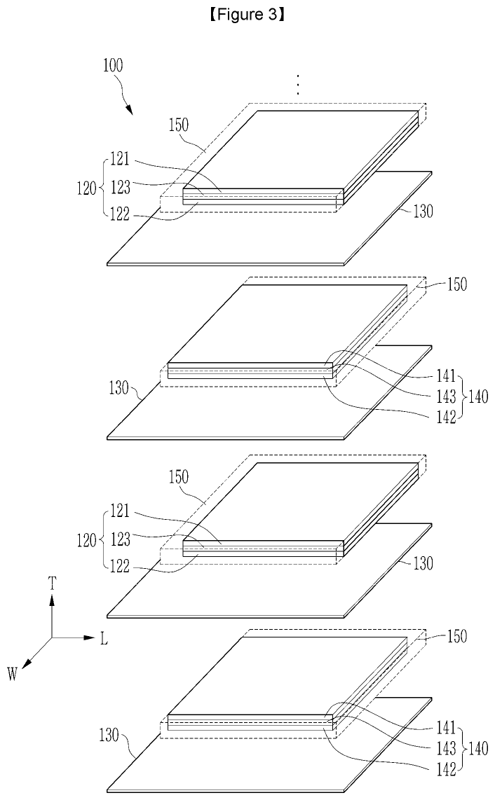

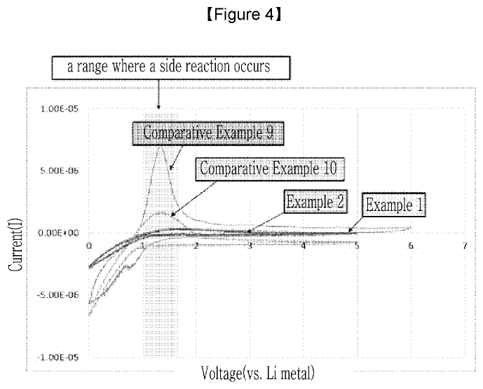

FIG. 1 is a perspective view schematically illustrating an all-solid-state battery according to an embodiment, FIG. 2 is a cross-sectional view of an all-solid-state battery according to the embodiment shown in FIG. 1, and FIG. 3 is an exploded perspective view schematically illustrating a unit cell stack structure of an all-solid-state battery according to the embodiment shown in FIG. 1.

The all-solid-state battery 100 may have, for example, an approximate hexahedral shape.

An all-solid-state battery 100 according to an embodiment includes electrode layers 120 and 140 and a solid electrolyte layer 130 adjacent to the electrode layers 120 and 140 in a stacking direction. The electrode layers 120 and 140 include a positive electrode layer 120 and a negative electrode layer 140, and basically the current collectors 123 and 143 and the active material layers 121, 122, 141, and 142 coated on at least one surface of the current collectors 123 and 143.

The positive electrode layer 120 is formed by coating the positive electrode active material layers 121 and 122 on at least one surface of the positive electrode current collector 123, and the negative electrode layer 140 is formed by coating the negative electrode active material layers 141 and 142 on at least one surface of the negative electrode current collector 143. For example, in the stacking direction, the uppermost electrode layer is formed by coating the positive electrode active material layer 122 on one surface of the positive electrode current collector 123, and the lowermost electrode layer may be formed by coating the negative electrode active material layer 141 on one surface of the negative electrode current collector 143. In addition, the electrode layers between the uppermost and lowermost ends are formed by coating the positive electrode active material layers 121 and 122 on both surfaces of the positive electrode current collector 123, or the negative electrode active material layers 141 and 142 are formed on both surfaces of the negative electrode current collector 143.

The positive electrode active material layers 121 and 122 may include a positive electrode active material and, optionally, a solid electrolyte. In addition, the positive electrode active material layers 121 and 122 may optionally further include an additive such as a binder or a conductive agent.

For example, the positive electrode active material is not particularly limited as long as it can secure sufficient capacity of the all-solid-state battery 100. For example, positive electrode active material may include lithium cobalt oxide, lithium nickel cobalt manganese oxide, lithium nickel cobalt aluminum oxide, lithium iron phosphate, lithium manganese oxide, or a combination thereof.

For example, the positive electrode active material may be compounds represented by the following chemical formulas: LiₐA_{l-b}M_{b}D₂ (wherein 0.90≤a≤1.8, 0≤b≤0.5); LiₐE_{l-b}M_{b}O_{2-c}D_{c} (wherein 0.90≤a≤1.8, 0≤b≤0.5, 0≤c≤0.05); LiE_{2-b}M_{b}O_{4-c}D_{c} (wherein 0≤b≤0.5, 0≤c≤0.05); LiₐNi_{1-b-c}Co_{b}M_{c}D_{α} (wherein 0.90≤a≤1.8, 0≤b≤0.5, 0≤c≤0.05, 0<α≤2); LiₐNi_{1-b-c}Co_{b}M_{c}O_{2-α}X_{α} (wherein 0.90≤a≤1.8, 0≤b≤0.5, 0≤c≤0.05, 0<α<2); LiₐNi_{1-b-c}CO_{b}M_{c}O_{2-α}X₂ (wherein 0.90≤a≤1.8, 0≤b≤0.5, 0≤c≤0.05, 0<α<2); LiₐNi_{1-b-c}Mn_{b}M_{c}D_{α} (wherein 0.90≤a≤1.8, 0≤b≤0.5, 0≤c≤0.05, 0<α≤2); LiₐNi_{1-b-c}Mn_{b}M_{c}O_{2-α}X_{α} (wherein 0.90≤a≤1.8, 0≤b≤0.5, 0≤c≤0.05, 0<α<2); LiₐNi_{1-b-c}Mn_{b}M_{c}O_{2-α}X₂ (wherein 0.90≤a≤1.8, 0≤b≤0.5, 0≤c≤0.05, 0<α<2); LiₐNi_{b}E_{c}G_{d}O₂ (wherein 0.90≤a≤1.8, O≤b≤0.9, 0≤c≤0.5, 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, 0.001≤e≤0.1); LiₐNiGbO₂ (wherein 0.90≤a≤1.8, 0.001≤b≤0.1); LiₐCoGbO₂ (wherein 0.90≤a≤1.8, 0.001≤b≤0.1); LiₐMnGbO₂ (wherein 0.90≤a≤1.8, 0.001≤b≤0.1); LiₐMn₂GbO₄ (wherein 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (wherein 0≤f≤2); and LiFePO₄, wherein in the above chemical formulas, A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V, Cr, Mn, Co, Ni, or Cu.

The positive electrode active material may also be LiCoO₂, LiMnₓO₂ₓ (wherein x=1 or 2), LiNi₁₋ₓMnₓO₂ₓ (wherein 0<x<1), LiNi_{1-x-y}CoₓMn_{y}O₂ (wherein 0≤x≤0.5, 0≤y≤0.5), LiFePO₄, TiS₂, FeS₂, TiS₃, or FeS₃.

The positive electrode layer 120 may further include a solid electrolyte. The type of solid electrolyte included in the positive electrode layer 120 is not particularly limited, but may include the same type of solid electrolyte as the aforementioned composite solid electrolyte. A content of the solid electrolyte may be greater than or equal to 0.1 parts by weight, greater than or equal to 1 part by weight, or greater than or equal to 10 parts by weight, and less than or equal to 80 parts by weight, less than or equal to 60 parts by weight, or less than or equal to 50 parts by weight based on 100 parts by weight of the total amount of the positive electrode active material.

The conductive agent is not particularly limited as long as it has conductivity without causing chemical change in the all-solid-state battery 100. For example, examples of the conductive agent may include graphite such as natural graphite and artificial graphite; carbon-based substances such as carbon black, acetylene black, ketjen black, channel black, furnace black, lamp black, and summer black; conductive fibers such as carbon fibers and metal fibers; fluorinated carbon; metal powders such as aluminum and nickel powder; conductive whiskers such as zinc oxide and potassium titanate; conductive metal oxides such as titanium oxide; or conductive materials such as polyphenylene derivatives.

A content of the conductive agent may be 1 part by weight to 10 parts by weight, or for example, 2 parts by weight to 5 parts by weight, based on 100 parts by weight of the positive electrode active material. When the content of the conductive agent is within the above range, a finally obtained electrode may have excellent conductivity characteristics.

The binder may be used to improve bonding strength between an active material and a conductive agent. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluororubber, or various copolymers, and the like.

A content of the binder may be 1 part by weight to 50 parts by weight, or for example, 2 parts by weight to 5 parts by weight, based on 100 parts by weight of the total positive electrode active material. When the content of the binder satisfies the above range, the active material layer may have high bonding strength.

The positive electrode current collector 123 is not particularly limited as long as it has conductivity without causing chemical change to the positive electrode or battery. For example, examples of the positive electrode current collector may include graphite such as natural graphite and artificial graphite; a carbon-based material such as carbon black, acetylene black, ketjen black, channel black, furnace black, lamp black, and summer black; a conductive fiber such as a carbon fiber or a metal fiber. In addition, as the positive electrode current collector, a porous material such as a mesh or mesh shape may be used, and a porous metal plate such as stainless steel, nickel, or aluminum may be used. In addition, the positive electrode current collector 123 may be coated with an oxidation-resistant metal or alloy film to prevent oxidation.

The negative electrode active material layers 141 and 142 may include a negative electrode active material and, optionally, a solid electrolyte.

The negative electrode active material may be a carbon-based material, silicon, a silicon oxide, a silicon-based alloy, a silicon-carbon-based material composite, tin, a tin-based alloy, a tin-carbon composite, a metal oxide, or a combination thereof, and may include a lithium metal and/or a lithium metal alloy.

The lithium metal alloy may include lithium and a metal/semi-metal capable of alloying with lithium. For example, the metal/semi-metal capable of alloying with lithium may include Si, Sn, Al, Ge, Pb, Bi, Sb, a Si—Y alloy (wherein Y is an alkali metal, an alkaline-earth metal, Group 13 to Group 16 elements, a transition metal, a rare earth element, or a combination thereof, and Si is not included), a Sn—Y alloy (wherein Y is an alkali metal, an alkaline earth metal, Group 13 to Group 16 elements, a transition metal, a transition metal oxide such as lithium titanium oxide (Li₄Ti₅O₁₂), a rare earth element, or a combination thereof, and Sn is not included), or MnOₓ (0<x≤2).

The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

In addition, the oxide of a metal/semi-metal capable of alloying with lithium may be lithium titanium oxide, vanadium oxide, lithium vanadium oxide, SnO₂, SiOₓ (0<x<2), and the like. For example, the negative electrode active material may include one or more elements selected from elements of Groups 13 to 16 of the periodic table of elements. For example, the negative electrode active material may include one or more elements selected from the group consisting of Si, Ge, and Sn.

The carbon-based material may be crystalline carbon, amorphous carbon, or a mixture thereof. The crystalline carbon may include graphite, such as natural graphite or artificial graphite in irregular, plate, flake, spherical, or fibrous form. In addition, the amorphous carbon may include soft carbon (low temperature calcined carbon) or hard carbon, a mesophase pitch carbonization product, calcined coke, graphene, carbon black, fullerene soot, a carbon nanotube, a carbon fiber, and the like.

The silicon may be Si, SiOₓ (0<x<2, for example 0.5 to 1.5), Sn, SnO₂, a silicon-containing metal alloy, or a mixture thereof. The silicon-containing metal alloy may include, for example, silicon and one or more of Al, Sn, Ag, Fe, Bi, Mg, Zn, in, Ge, Pb, and Ti.

The negative electrode layer 140 may further include a solid electrolyte. The type of solid electrolyte included in the negative electrode layer 140 is not particularly limited, but may include the same type of solid electrolyte as the aforementioned composite solid electrolyte.

The negative electrode active material layer may also optionally further include a conductive agent and a binder as described in the positive electrode active material layer.

The negative electrode current collector 143 is not particularly limited as long as it has conductivity without causing chemical change to the negative electrode or battery. For example, examples of the negative electrode current collector may include graphite such as natural graphite and artificial graphite; a carbon-based material such as carbon black, acetylene black, ketjen black, channel black, furnace black, lamp black, and summer black; a conductive fiber such as a carbon fiber or a metal fiber. In addition, as the negative electrode current collector, a porous material such as a mesh or mesh shape may be used, and a porous metal plate such as stainless steel, nickel, or aluminum may be used. In addition, the negative electrode current collector 143 may be coated with an oxidation-resistant metal or alloy film to prevent oxidation.

The solid electrolyte layer 130 may be disposed and stacked between the positive electrode layer 120 and the negative electrode layer 140. Accordingly, the solid electrolyte layer 130 may be adjacently disposed between the positive electrode active material layers 121 and 122 of the positive electrode layer 120 and the negative electrode active material layers 141 and 142 of the negative electrode layer 140 in the stacking direction. Therefore, in the all-solid-state battery 100, a plurality of positive electrode layers 120 and a plurality of negative electrode layers 140 may be alternately disposed, and a plurality of solid electrolyte layers 130 may be interposed and stacked therebetween. In the all-solid-state battery 100, a plurality of positive electrode layers 120 and negative electrode layers 140 are alternately stacked, and a plurality of solid electrolyte layers 130 are interposed therebetween to manufacture a cell stack, and then the cell stack may be batch-fired to manufacture a stacked all-solid-state battery 100.

The solid electrolyte layer 130 includes the composite solid electrolyte described above. Since the composite solid electrolyte has been described in detail above, a description thereof will be omitted.

By including the composite solid electrolyte having the excellent effect described above in the solid electrolyte layer 130, side reactions do not occur in the operating voltage range of 0.75 to 1.5V, and thus it may be driven in all operating voltage ranges of 0 to 6V. In addition, since there is no need to avoid the side reaction range, there is an advantage in that the types of selectable electrode active materials are expanded.

A margin layer 150 may be disposed along edges of the positive electrode layer 120 and the negative electrode layer 140. The margin layer 150 is disposed on the solid electrolyte layer 130 and may be formed laterally adjacent to edges of the positive electrode active material layers 121 and 122 or the negative electrode active material layers 141 and 142. Accordingly, the margin layer 150 may be disposed on the same layer as the positive electrode layer 120 and the negative electrode layer 140.

The margin layer 150 may include an insulating material having an ionic conductivity of less than or equal to 1.0×10⁻¹⁰ S/cm, for example, an insulating material such as the aforementioned solid electrolyte material or resin.

For example, the insulation material may be a polyolefin such as polyethylene or polypropylene and the like, a polyester such as polyethylene terephthalate (PET) and the like, polyurethane, or polyimide.

In addition, the margin layer 150 may include an inorganic solid electrolyte including an oxide-based solid electrolyte used in the solid electrolyte layer 130, a sulfide-based solid electrolyte, or a combination thereof. However, the margin layer 150 are not limited thereto but may include various materials.

The positive electrode layer 120, the solid electrolyte layer 130, the negative electrode layer 140, and the margin layer 150 may be stacked as described above to form a cell stack of the all-solid-state battery 100. A protective layer (not shown) made of an insulating material may be formed on the upper and lower ends of the cell stack of the all-solid-state battery 100.

In addition, terminals of the positive current collector 123 and terminals of the negative current collector 143 are exposed on both sides of the cell stack of the all-solid-state battery 100, and external electrodes 112 and 114 may be connected to and coupled to the exposed terminals. That is, the external electrode 112 may be configured to be connected to terminals of the positive current collector 123 to have positive poles, and the external electrode 114 may be connected to terminals of negative current collector 143 to have negative poles. When the terminals of the positive current collector 123 and the terminals of the negative current collector 143 are configured to face in opposite directions, the external electrodes 112 and 114 may also be disposed on both sides, respectively.

The external electrodes 112 and 114 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

A glass component included in the external electrodes 112 and 114 may have a composition in which an oxide is mixed. The glass component may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba).

A method of forming the external electrodes 112 and 114 is not particularly limited. For example, the method may include dipping the cell stack in a conductive paste including a conductive metal and glass or screen-printing or gravure-printing the conductive paste on the surface of the cell stack. In addition, various methods of applying the conductive paste on the surface of the cell stack or transferring a dry film obtained by drying the conductive paste onto the cell stack may be used.

Hereinafter, specific examples of the invention are presented. However, the examples described below are only intended to specifically illustrate or explain the invention, and the scope of the invention should not be limited thereto.

### EXAMPLES

### Example 1

Li₇La₃Zr₂O₁₂ (hereinafter, referred to as LLZO), Li_{10.42}Si_{1.5}P_{1.5}Cl_{0.08}O_{11.92}, and Li₃BO₃ are weighed and mixed in a volume ratio of 45:45:10. The mixture is mixed with a binder and a binder solvent and then, ball-milled at room temperature for 24 hours or more, so that they may be sufficiently uniformly mixed. The solvent is dried in an oven, obtaining mixed powder coated with the binder.

Subsequently, a solid electrolyte layer green sheet including the mixed composite solid electrolyte, a positive electrode layer green sheet, and a negative electrode layer green sheet are manufactured, stacked in an order of the positive electrode layer green sheet—the solid electrolyte layer green sheet—the negative electrode layer green sheet, and heat-treated under an oxygen atmosphere at 250 to 600° C. to remove the binder. After removing the binder, the stack is fired at 800° C. under an oxygen atmosphere, manufacturing a unit cell.

### Example 2

A unit cell is manufactured in the same manner as in Example 1 except that the heat treatment is performed at 700° C.

### Example 3

A unit cell is manufactured in the same manner as in Example 1 except that a composite solid electrolyte is prepared by mixing LLZO, Li_{10.42}Si_{1.5}P_{1.5}Cl_{0.08}O_{11.92}, and Li₃BO₃ in a volume ratio of 20:65:15.

### Example 4

A unit cell is manufactured in the same manner as in Example 1 except that a composite solid electrolyte is prepared by mixing LLZO, Li_{10.42}Si_{1.5}P_{1.5}Cl_{0.08}O_{11.92}, and Li₃BO₃ in a volume ratio of 75:15:10.

### Comparative Example 1

A unit cell is manufactured in the same manner as in Example 1 except that a solid electrolyte is prepared by using 100 vol % of LLZO, and the firing temperature is set at 1000° C.

### Comparative Example 2

A unit cell is manufactured in the same manner as in Example 1 except that a solid electrolyte is prepared by using 100 vol % of Li_{10.42}Si_{1.5}P_{1.5}Cl_{0.08}O_{11.92}, and the firing temperature is set at 1000° C.

### Comparative Example 3

A unit cell is manufactured in the same manner as in Example 1 except that a solid electrolyte is prepared by using 100 vol % of Li₃BO₃, and the firing temperature is set at 700° C.

### Comparative Example 4

A unit cell is manufactured in the same manner as in Example 1 except that a composite solid electrolyte is prepared by mixing LLZO and Li₃BO₃ in a volume ratio of 95:5, and the firing temperature is set at 800° C.

### Comparative Example 5

A unit cell is manufactured in the same manner as in Comparative Example 4 except that a composite solid electrolyte is prepared by mixing LLZO and Li₃BO₃ in a volume ratio of 90:10.

### Comparative Example 6

A unit cell is manufactured in the same manner as in Comparative Example 4 except that a composite solid electrolyte is prepared by mixing LLZO and Li₃BO₃ in a volume ratio of 85:15.

### Comparative Example 7

A unit cell is manufactured in the same manner as in Example 1 except that a composite solid electrolyte is prepared by mixing Li_{10.42}Si_{1.5}P_{1.5}Cl_{0.08}O_{11.92} and Li₃BO₃ in a volume ratio of 85:15.

### Comparative Example 8

A unit cell is manufactured in the same manner as in Comparative Example 2 except that a composite solid electrolyte is prepared by using 100 vol % of Li_{3.2}(V_{0.8}Si_{0.2})O₄ instead of the Li_{10.42}Si_{1.5}P_{1.5}Cl_{0.08}O_{11.92}.

### Comparative Example 9

A unit cell is manufactured in the same manner as in Example 1 except that a composite solid electrolyte is prepared by mixing LLZO, Li_{3.2}(V_{0.8}Si_{0.2})O₄, and Li₃BO₃ in a volume ratio of 45:45:10.

### Comparative Example 10

A unit cell is manufactured in the same manner as in Example 1 except that a composite solid electrolyte is prepared by mixing LLZO, Li_{3.2}(V_{0.8}Si_{0.2})O₄, and Li₃BO₃ in a volume ratio of 75:15:10.

### Comparative Example 11

A unit cell is manufactured in the same manner as in Comparative Example 2 except that a solid electrolyte is prepared by using 100 vol % of Li_{10.5}Si_{1.5}P_{1.5}O₁₂ instead of the Li_{10.42}Si_{1.5}P_{1.5}Cl_{0.08}O_{11.92}.

### Comparative Example 12

A unit cell is manufactured in the same manner as in Example 1 except that a composite solid electrolyte is prepared by mixing LLZO, Li_{10.5}Si_{1.5}P_{1.5}O₁₂, and Li₃BO₃ in a volume ratio of 45:45:10.

The aforementioned compositions and firing temperatures of Examples 1 to 4 and Comparative Examples 1 to 12 are shown in Table 1.

TABLE 1

| | | | Oxide | | |
|---|---|---|---|---|---|
| | | | containing | | |
| | Garnet- | | Li | Volume | Firing |
| | type | | and B | ratio | temperature |
| | (X) | LISICON-type (Y) | (Z) | (X:Y:Z) | (° C.) |
| Example 1 | LLZO | Li_{10.42}Si_{1.5}P_{1.5}Cl_{0.08}O_{11.92} | Li₃BO₃ | 45:45:10 | 800 |
| Example 2 | LLZO | Li_{10.42}Si_{1.5}P_{1.5}Cl_{0.08}O_{11.92} | Li₃BO₃ | 45:45:10 | 700 |
| Example 3 | LLZO | Li_{10.42}Si_{1.5}P_{1.5}Cl_{0.08}O_{11.92} | Li₃BO₃ | 20:65:15 | 800 |
| Example 4 | LLZO | Li_{10.42}Si_{1.5}P_{1.5}Cl_{0.08}O_{11.92} | Li₃BO₃ | 75:15:10 | 800 |
| Comparative | LLZO | — | — | 100:0:0 | 1000 |
| Example 1 | | | | | |
| Comparative | — | Li_{10.42}Si_{1.5}P_{1.5}Cl_{0.08}O_{11.92} | — | 0:100:0 | 1000 |
| Example 2 | | | | | |
| Comparative | — | — | Li₃BO₃ | 0:0:100 | 700 |
| Example 3 | | | | | |
| Comparative | LLZO | — | Li₃BO₃ | 95:0:5 | 800 |
| Example 4 | | | | | |
| Comparative | LLZO | — | Li₃BO₃ | 90:0:10 | 800 |
| Example 5 | | | | | |
| Comparative | LLZO | — | Li₃BO₃ | 85:0:15 | 800 |
| Example 6 | | | | | |
| Comparative | — | Li_{10.42}Si_{1.5}P_{1.5}Cl_{0.08}O_{11.92} | Li₃BO₃ | 0:85:15 | 800 |
| Example 7 | | | | | |
| Comparative | — | Li_{3.2} (V_{0.8}Si_{0.2})O₄ | — | 0:100:0 | 1000 |
| Example 8 | | | | | |
| Comparative | LLZO | Li_{3.2} (V_{0.8}Si_{0.2})O₄ | Li₃BO₃ | 45:45:10 | 800 |
| Example 9 | | | | | |
| Comparative | LLZO | Li_{3.2} (V_{0.8}Si_{0.2})O₄ | Li₃BO₃ | 75:15:10 | 800 |
| Example 10 | | | | | |
| Comparative | — | Li_{10.5}Si_{1.5}P_{1.5}O₁₂ | — | 0:100:0 | 1000 |
| Example 11 | | | | | |
| Comparative | LLZO | Li_{10.5}Si_{1.5}P_{1.5}O₁₂ | Li₃BO₃ | 45:45:10 | 800 |
| Example 12 | | | | | |

### EXPERIMENTAL EXAMPLES

### Experimental Example 1: Measurement of Relative Density

The unit cells according to Examples 1 to 4 and Comparative Examples 1 to 12 are ion-milled or polished to expose each of the solid electrolyte layer, and the exposed solid electrolyte surfaces are subjected to X-ray diffraction analysis to calculate a true density.

Each of the solid electrolyte layers, which is exposed in the same manner as above and then, is sampled into a rectangular plate piece.

The plate piece is measured with respect to mass, which is divided by a calculated apparent volume to obtain an apparent density. The apparent density is divided by the true density to obtain a relative density (%), and these results are shown in Table 2.

Referring to Table 2, Examples 1 to 3, in which the solid electrolyte layers are prepared by mixing LLZO, Li_{10.42}Si_{1.5}P_{1.5}Cl_{0.08}O_{11.92}, and Li₃BO₃ in a specific volume ratio, exhibit a high relative density of 80% or more.

On the other hand, Comparative Examples 1 to 12 exhibit a low relative density of less than 80%.

Herein, Comparative Example 9 exhibits somewhat high relative density but has a side reaction, which results in a lower overall effect than the examples.

### Experimental Example 2: Measurement of Lithium Ionic Conductivity

An AC impedance method is used to measure lithium ionic conductivity of the solid electrolytes of Examples 1 to 4 and Comparative Examples 1 to 12. First of all, each unit cell is ion-milled or polished to expose its solid electrolyte layer and sample a portion of the solid electrolyte layer into a rectangular plate piece. Subsequently, at both ends of the obtained piece, electrodes made of gold (Au) are formed, preparing a sample. The sample is measured with respect to AC impedance (frequency: 10⁺⁶ Hz or more to 10⁻¹ Hz or less, voltage: 50 mV to 500 mV) at room temperature (25° C.) by using an impedance measuring device, which is used to calculate the lithium ionic conductivity, and the results are shown in Table 2.

‘Less than E-08’ indicates a case where that a measurement result is less than 1.0·E-08 S/cm.

‘Not measurable’ indicates a case where lithium ionic conductivity of a sample is too low to proceed with electrochemical analysis.

Referring to Table 2, the examples exhibit higher lithium ionic conductivity than the comparative examples.

Comparative Examples 8 and 9 exhibit somewhat high lithium ionic conductivity but have a side reaction, resulting in a lower overall effect than the examples.

### Experimental Example 3: Side Reaction Occurrence

Since the side reaction is an oxidation-reduction reaction of an element included in a solid electrolyte (e.g., V (vanadium) of Comparative Examples 8 and 9), when the side reaction occurs, an all-solid-state battery may not normally operate. Whether or not this side reaction occurs is checked through an electrochemical analysis, which is a cyclic voltammetry (CV) analysis. Since this analysis is a method of recording whether or not a current occurs within a voltage range in which the analysis proceeds, a current occurs within the specific voltage range, which confirms that an electrochemical reaction proceeds in the corresponding voltage range. For example, when a peak appears in the + direction or the − direction on a y-axis of a graph, the electrochemical reaction is confirmed to proceed within the corresponding voltage range. Herein, the graph goes down within the range of 0.0 to 0.5 V, which is caused by the Li metal interface but not regarded as the side reaction.

This analysis is performed within the range of 0.0 to 6.0 V, compared with Li metal (vs. Li/Li+), and the results are given as ‘No’, ‘Yes’, or ‘Not measurable’ in Table 2. ‘Not measurable’ indicates a case where lithium ionic conductivity of a sample is too low to proceed with electrochemical analysis. In addition, the side reaction analysis results of Examples 1 and 2 and Comparative Examples 9 and 10 are shown as graphs in FIG. 4.

Referring to Table 2, Examples 1 to 4 have no side reaction, but Comparative Examples 8 to 10, which include a LISICON-type solid electrolyte including V (vanadium), have a side reaction.

Referring to FIG. 4, Examples 1 and 2 have no side reaction at 0.75 to 1.5 V (a range where a side reaction occurs), but Comparative Examples 9 and 10 have a side reaction within the corresponding range. Comparative Example 10 exhibits a smaller current peak in the side reaction-occurring range than Comparative Example 9, because Comparative Example 10 includes smaller vol % of the LISICON-type solid electrolyte than Comparative Example 9. The side reaction may exhibit a different current peak size according to a volume ratio of each solid electrolyte in a composite solid electrolyte, but no matter how small the side reaction occurs, an all-solid-state battery may not normally operate within the corresponding voltage range.

TABLE 2

| | Relative | Ionic conductivity | Side reaction |
|---|---|---|---|
| | density (%) | (S/cm) | occurrence |
| Example 1 | 83.3 | 2.73 · E−06 | No |
| Example 2 | 80.4 | 7.95 · E−07 | No |
| Example 3 | 88.5 | 4.0 · E−06 | No |
| Example 4 | 64.0 | 1.3 · E−07 | No |
| Comparative Example 1 | 61.5 | Less than E−08 | Not measurable |
| Comparative Example 2 | 75.2 | 4.1 · E−07 | No |
| Comparative Example 3 | 75.2 | Less than E−08 | Not measurable |
| Comparative Example 4 | 48.6 | Not measurable | Not measurable |
| Comparative Example 5 | 49.8 | Not measurable | Not measurable |
| Comparative Example 6 | 52.8 | Not measurable | Not measurable |
| Comparative Example 7 | 65.6 | 1.7 · E−08 | Not measurable |
| Comparative Example 8 | 69.2 | 3.2 · E−06 | Yes |
| Comparative Example 9 | 91.2 | 3.9 · E−06 | Yes |
| Comparative Example 10 | 67.5 | 1.63 · E−07 | Yes |
| Comparative Example 11 | 74.5 | 4.9 · E−08 | Not measurable |
| Comparative Example 12 | 79.7 | 3.3 · E−07 | No |

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### INDUSTRIAL APPLICABILITY

The present disclosure relates to a composite solid electrolyte that can lower the firing temperature, does not cause side reactions in the operating voltage range of 0 to 6V, has high relative density, and has high lithium ionic conductivity and an all-solid-state battery including the same, and thus it can be used in various electrochemical devices and electronic devices.

### DESCRIPTION OF SYMBOLS

100: all-solid-state battery
112, 114: external electrode
120: positive electrode layer
121, 122: positive electrode active material layer
123: positive electrode current collector
130: solid electrolyte layer
140: negative electrode layer
141, 142: negative electrode active material layer
143: negative electrode current collector
150: margin layer

1. A composite solid electrolyte, comprising:
a Garnet-type solid electrolyte; and
a LISICON-type solid electrolyte containing Cl element.

2. The composite solid electrolyte of claim 1, wherein
the LISICON-type solid electrolyte is represented by Chemical Formula 1:
LiₐM_{b}P_{c}Cl_{d}Oₑ [Chemical Formula 1]
wherein M includes Zn, Al, Ga, Si, Ge, Ti, Mg, or a combination thereof, and
a, b, c, d, and e are molar ratios of each component, and satisfy 5≤a≤12, 0<b≤3, 0<c≤3, 0<d≤0.1, and 10≤e≤12.

3. The composite solid electrolyte of claim 2, wherein
the M include Si (silicon) or Ge (germanium).

4. The composite solid electrolyte of claim 2, wherein
the M does not include V (vanadium).

5. The composite solid electrolyte of claim 1, further comprising an oxide containing Li and B elements.

6. The composite solid electrolyte of claim 5, wherein
the oxide containing Li and B elements is included in an amount of 5 to 20 vol % based on the total volume of the composite solid electrolyte.

7. The composite solid electrolyte of claim 5, wherein
a ratio of a sum of volumes of the Garnet-type solid electrolyte and the LISICON-type solid electrolyte to a volume of the oxide containing Li and B elements is 80:20 to 90:10.

8. The composite solid electrolyte of claim 5, wherein
the oxide containing Li and B elements includes Li₃BO₃, Li₄B₂O₅, LiBO₂, or a combination thereof.

9. The composite solid electrolyte of claim 1, wherein
the Garnet-type solid electrolyte is included in an amount of 10 to 50 vol % based on the total volume of the composite solid electrolyte.

10. The composite solid electrolyte of claim 1, wherein
the LISICON-type solid electrolyte is included in an amount of 40 to 80 vol % based on the total volume of the composite solid electrolyte.

11. The composite solid electrolyte of claim 1, wherein
a ratio of a volume of the Garnet-type solid electrolyte to a volume of the LISICON-type solid electrolyte is 10:80 to 45:45.

12. The composite solid electrolyte of claim 1, wherein
a ratio of a volume of the Garnet-type solid electrolyte to a volume of the LISICON-type solid electrolyte is 10:80 to 75:15.

13. The composite solid electrolyte of claim 1, wherein
the composite solid electrolyte has a relative density (%) of greater than or equal to 80%.

14. The composite solid electrolyte of claim 1, wherein
the composite solid electrolyte has room-temperature (25° C.) lithium ionic conductivity of greater than or equal to 1×10⁻⁷(S/cm).

15. The composite solid electrolyte of claim 2, wherein
LiₐM_{b}P_{c}Cl_{d}Oₑ includes Li_{10.42}Si_{1.5}P_{1.5}Cl_{0.08}O_{11.92}.

16. An all-solid-state battery, comprising:
a solid electrolyte layer; and
a positive electrode layer and a negative electrode layer with the solid electrolyte layer disposed therebetween,
wherein the solid electrolyte layers include a composite solid electrolyte,
the composite solid electrolyte includes a Garnet (LLZO)-type solid electrolyte and a LISICON-type solid electrolyte containing a Cl element.

17. The all-solid-state battery of claim 16, wherein
the LISICON-type solid electrolyte is represented by Chemical Formula 1:
LiₐM_{b}P_{c}Cl_{d}Oₑ [Chemical Formula 1]
wherein M includes Zn, Al, Ga, Si, Ge, Ti, Mg, or a combination thereof, and
a, b, c, d, and e are molar ratios of each component, and satisfy 5≤a≤12, 0<b≤3, 0<c≤3, 0<d≤0.1, and 10≤e≤12.

18. The all-solid-state battery of claim 16, further comprising an oxide containing Li and B elements.

19. The all-solid-state battery of claim 17, wherein
LiₐM_{b}P_{c}Cl_{d}Oₑ includes Li_{10.42}Si_{1.5}P_{1.5}Cl_{0.08}O_{11.92}.

20. An all-solid-state battery, comprising:
a stack including a plurality of solid electrolyte layers and a plurality of positive electrode layers and negative electrode layers alternately with the plurality of solid electrolyte layers disposed therebetween, and
first and second external electrodes disposed on one surface and the other surface opposite to the one surface of the stack and connected to the positive electrode layers and the negative electrode layers, respectively,
wherein the solid electrolyte layers include a composite solid electrolyte, and
the composite solid electrolyte includes a Garnet (LLZO)-type solid electrolyte and a LISICON-type solid electrolyte containing a Cl element.

21. The all-solid-state battery of claim 20, wherein
the LISICON-type solid electrolyte is represented by Chemical Formula 1:
LiₐM_{b}P_{c}Cl_{d}Oₑ [Chemical Formula 1]
wherein M includes Zn, Al, Ga, Si, Ge, Ti, Mg, or a combination thereof, and
a, b, c, d, and e are molar ratios of each component, and satisfy 5≤a≤12, 0<b≤3, 0<c≤3, 0<d≤0.1, and 10≤e≤12.

22. The all-solid-state battery of claim 20, further comprising an oxide containing Li and B elements.

23. The all-solid-state battery of claim 21, wherein
LiₐM_{b}P_{c}Cl_{d}Oₑ includes Li_{10.42}Si_{1.5}P_{1.5}Cl_{0.08}O_{11.92}.
